(19) United States
(12) Patent Application Publication
(10) Pub. No.: US 2005/0053794 A1
(43) Pub. Date: Mar. 10, 2005

(54) Metallized composite

(76) Inventor: Shu Liu, Pittsburgh, PA (US)

Correspondence Address: BAYER MATERIAL SCIENCE LLC, 100 BAYER ROAD, PITTSBURGH, PA, 15205, US

(21) Appl. No.: 10/658,048

(22) Filed: Sep. 9, 2003

(51) Int. Cl. B32B 15/04; B32B 15/08

(52) U.S. Cl. 428/458; 428/462; 428/463

(57) ABSTRACT

A multi-layered metal/organic polymer composite exhibiting desirable decorative and forming characteristics is disclosed. The composite includes in sequence a first polymeric layer, a metal layer, an adhesive layer and a second polymeric layer. The composite is especially suitable for preparing formed laminates that are useful in film insert molding application.

The invention relates to a multi-layered composite and more particularly to a film laminate containing at least one metal layer.

### SUMMARY OF THE INVENTION

A multi-layered metal/organic polymer composite exhibiting desirable decorative and forming characteristics is disclosed. The composite includes in sequence a first polymeric layer, a metal layer, an adhesive layer and a second polymeric layer. The composite is especially suitable for preparing formed laminates that are useful in film insert molding applications.

### BACKGROUND OF THE INVENTION

Metallized plastic articles are known. Included are films that carry a metal layer applied to the surface of film by such methods as vacuum, electrolytic or electroless depositions. Also known is the use of metallized films in film insert molding applications where the metal layer is made to provide decorative and/or reflective appearance to a molded article.

The technique known as film-insert-molding has also been described, see, for instance, U.S. Pat. No. 5,783,287, and is widely practiced. Essentially, the method entails positioning a film against the inside wall of a mold cavity and injecting molten plastic into the mold cavity, directing the molten plastic against the film. As a result, the molded article thus formed has at least part of its surface covered by the film.

In the instances where the film needs to be shaped so to conform to the inner surface of a mold cavity, the film is strained beyond its elastic limit. In the instances where the film to be thus shaped has been metallized, care needs to be taken to avoid exceeding the plastic limit and rupture. Unfortunately, the degree to which such conventional metallized films can be shaped without rupture and/or separation of the metal from the polymer is limited. Exceeding this limit brings about noticeable loss of quality in the appearance of the metallized article.

A multi-layered, metal/organic polymer composite, exhibiting high specular reflectivity even after substantial elongation, has been disclosed in U.S. Pat. No. 4,115,610. That composite is provided by metallizing a layer of thermoplastic organic polymers such as polystyrene or polycarbonate film with a normally solid soft metal such as indium or an alloy of tin and cadmium. Subsequently, the thus disclosed multi-layered composite is said to withstand stretching of more than 10 percent in both longitudinal and traverse directions without losing its specular reflectivity. Articles fabricated of the multi-layered composite are said to be structurally reinforced by casting an elastomeric or rigid foam polymer such as polyurethane into a cavity defined by the deposit. The multi-layered composites are said to be useful in the manufacture of reflective and decorative parts.

A metal/organic polymer composite exhibiting excellent resistance to delamination after thermoforming is said in U.S. Pat. No. 4,241,129 to be provided by metallizing a substrate layer of thermoplastic organic polymer such as polycarbonate film and bonding the exposed metal surface to a structural plastic with a soft adhesive layer. Subsequently, the multi-layered composite is said to be capable of being shaped into an article which may be structurally reinforced by casting an elastomeric or rigid foamed polymer into a cavity defined by the composite. This multi-layered composites are said to be useful in the manufacture of reflective and decorative parts for automobiles, as well as high barrier packages for foods and electroconductive elements.

Similar technology was disclosed in U.S. Pat. No. 4,211,822.

In accordance with its abstract, JP 59038238, disclosed a film produced by sputtering indium oxide-tin oxide alloy on plastics film. The alloy contained 8 to 14 wt. % tin. Polyester, polycarbonate and polyamides are mentioned among the suitable plastic films. The film, having good etching processability and evaporated film-adherence is said to have visible light-transmittance of above 80% and thickness of 20 to 200 microns. The film is said to have good chemical and mechanical resistance, and to be used as EL electrode and touch panels.

Laminate for decorative molding products, having a thin metallic film layer, formed on film base material has been disclosed in the abstract of JP 2000094575 A. The metal, indium or indium alloy has a thickness of 10 to 30 nm. The film base material is polyester having at least 85 mol % ethylene terephthalate. The thickness of the film is 20 to 75 microns. The indicated use of the laminate is for decorative molding products made of, among others, polycarbonate. An advantage is noted to be the avoidance of crack generation on the decorative molded article, as the laminate which has thin metal film formed on film base material, is used as a decorative integral laminate for providing metallic luster on the molded article during injection molding.

### DETAILED DESCRIPTION OF THE INVENTION

A multi-layered metal/organic polymer composite exhibiting desirable decorative and forming characteristics is disclosed. The composite includes as essential components a first polymeric layer, a metal layer, an adhesive layer and a second polymeric layer; other additional layers may be interposed between the essential components of the inventive composite. In the present context, the inventive composite is capable of being formed without causing significant rupture to any of the layers. The term “formed” as used to describe the inventive composite means that at least a portion thereof has been stretched to undergo a significant dimensional change. Quantitatively, at least a portion of the area of the composite has been extended to an extent that it is at least 5 percent greater than the area of the portion before forming. It is to be understood that mini-cracks brought about as a result of forming and which have no appreciable effect on the mirror-like appearance of the formed composite may be tolerated.

The polymeric layers of the inventive composite may be prepared by conventional means. Compositionally, each of the first and second polymeric layers may be of any one or blends of polycarbonate, polyester, polyacrylate, acrylonitrile-butadiene-styrene copolymer (ABS), polyamide, polyolefin, polyurethane, polyamide, polyimide and fluoropolymer. Films of such polymers suitable for the preparation of the inventive composite are known and are available in commerce. It is not necessary that the first polymeric film be compositionally identical to the second polymeric film. In the preferred embodiment of the invention, the first and second polymeric layers are of polycarbonate films. Suitable such polycarbonate films are available commercially under the trademark Makrofol from Bayer Polymers LLC, of Pittsburgh, Pa. Polycarbonate film is preferred because of its high light transmittance, low haze, high toughness and high heat deflection temperature. Furthermore, polycarbonate film is particularly suitable in applications where printing by conventional techniques such as screen and offset printing is desired. Moreover, polycarbonate film may be easily formed, stamped, die-cut, and embossed.

The thickness of the polymeric layers needs to be that which is sufficient to enable forming the composite and its survival under the conditions normal to the intended use of the composite. Generally, the thickness of the polymeric layers is in the range of 25 to 1,000 microns, preferably 50 to 500 microns, most preferably 100 to 150 microns. There are no restrictions imposed on the type of surfaces of the first and second polymeric surfaces and glossy, matte, velvet and suede surfaces in any combination are possible. It is preferred that both surfaces of the first polymeric layer be glossy and that the inside surface of the second polymeric layer, that is the surface in contact with the adhesive layer, be glossy and the outside surface of the second polymeric layer be matte. Having glossy finish for both surfaces of the first polymeric layer is preferred because this highly transparent layer with the underlying metallic layer provides a bright mirror-like appearance. The glossy inside surface of the second polymeric layer is preferred because any other texture of this surface renders the metallic layer susceptible to cracking through the adhesive layer in the downstream lamination and forming processes, thus damaging the mirror-like appearance. The matte outside surface of the second polymeric layer is helpful in avoiding air trap between the surface and the forming tool during the forming process.

The metal layer may comprise any of titanium, aluminum, copper, silver, chromium, zirconium, tin, indium and their alloys. Preferably, the metal layer comprises indium or an indium-tin alloy that contains indium in an amount of 5 to 100, preferably 85 to 95 weight percent (wt. %) and tin in an amount of 0 to 95, preferably 5 to 15 wt. %. The indium and indium-tin alloys are of sufficient ductility and may thus be formed without being ruptured. The proximity of their melt temperatures to the temperature ranges of the conventional forming technologies make these metals particularly suitable for the preparation of the formed composites of the invention. Another advantage of indium and indium-tin alloys over some metals such as aluminum is that they do not form an oxide film in moist air.

The inclusions in the alloy of additional metals is permissible as long as the mechanical and physical properties are not altered so as to render the alloy unsuitable for the purpose, namely preparing the claimed composite that is suitable for forming and application in the context of film insert molding. Examples of such additional metals include one or more of bismuth, lead, zinc, cadmium and antimony, copper, silver, magnesium, lead and aluminum.

The adhesive useful in the context of the present invention is water-based, solvent-based and hot-melt. Included among the suitable water-based adhesives are polyvinyl acetate, polyacrylate, polycholoroprene, polyurethane and natural rubber latex. Included among the suitable solvent-based adhesives are polychloroprene, styrene-butadiene, acrylonitrile butadiene, polyurethane, polyester, polyisobutylene, and polyacrylates. Included among the suitable hot-melt adhesives are ethylene vinyl acetate, polyethylene, polyolefin, block copolymer and polyamide. Water-based adhesives are preferred because they are easy to coat on polycarbonate films and they do not attack polycarbonate films.

Preferred water-based adhesives are aqueous anionic dispersions of high molecular weight polyurethane, containing the solid polymer in an amount of 10 to 80 wt. %, preferably 30 to 50 wt. %, and viscosity values in the range of 20 to 2000 cps, preferably 40 to 1000 cps. Suitable adhesives are available from Bayer Polymers LLC under the Dispercoll trademark. Dispercoll UKA 8758 is particularly preferred because it may be easily coated on a glossy polycarbonate film using conventional coating technologies such as gravure, reverse roll, and roll-over-roll coatings without special surface pretreatment or a primer coating. It forms excellent adhesion to both polycarbonate film surface and many metal surfaces. Since it is an amorphous adhesive, it does not form gels during the coating process, resulting in a coating-line free adhesive surface. It is particularly suitable for the backlit applications because it does not form crystalline white spots which adversely effect the cosmetics of the composite. The peel adhesion of the adhesive to the surface of the polycarbonate film increases with the coating thickness. However, an extreme coating thickness should be avoided because of high raw material cost, low coating speed, and poor drying. In this invention, it is preferred that the thickness of the adhesive layer be 18 to 30 microns, preferably 18 to 26 microns.

The multi-layered composites of the present invention may be prepared by any conventional method for making multi-layered metal/organic polymer composites wherein the layers of metal and polymer adhere to each other. For example, the metal may be applied as a coating by a conventional metallization technique such as an electroless process described by F. A. Lowenheim in “Metal Coatings of Plastics,” Noyes Date Corporation, (1970), by Pinter, S. H. et al., Plastics: Surface and Finish, Daniel Davey & Company, Inc., 172-186 (1971) or in U.S. Pat. No. 2,464,143. An especially preferred metallization technique in the practice of this invention is a vacuum deposition technique wherein the metal is vacuum evaporated and then deposited onto the polymer layer as described by William Goldie in Metallic Coating of Plastics, Vol. 1, Electrochemical Publications Limited, Chap. 12 (1968). Another preferred metallization technique includes sputter coating as described in Chapter 13 of Goldie, supra. Also suitable is electroplating and ion plating. In addition, the multi-layered composite may be formed by lamination of metal foil to the polymer layer including extrusion coating of the polymer layer onto a metal foil.

The thickness of the metal layer in the multi-layered composite is that which would form an essentially continuous film over the desired surface of the polymer layer and thereby provide a highly reflective surface, as the desired end use requires. In this invention, the thickness of the metal layer is determined by the desired light transmittance of the metallized polycarbonate film. When light transmittance is higher than 60%, the metal layer loses its shininess and appears brownish in color. Preferably, light transmittance is in the range of 0.1% to 60.0%, most preferably 0.2% to 40%. When the metallized composite is used in a backlit application, preferred light transmittance ranges from 0.3% to 30%, most preferably 1.7% to 25%.

The lamination of the metallic film with the adhesive-coated film may be carried out by conventional methods. The lamination temperature should balance the needs for preventing metal cracking and enhancing adhesion bonding. A low lamination temperature leads to a weak adhesion bonding of the adhesives to the metal layer surface. On the other hand, a high lamination temperature may rupture the metal layer. In this invention, when the metal layer is chromium or an In/Sn alloy, the preferred lamination temperature is in the range of 175° F. to 200° F.

Following the preparation of the multi-layered composite it may then be formed by a conventional forming process, e.g., thermoforming or solid phase forming, to the desired shape. Preferably, the forming process is a conventional thermoforming process for shaping sheet or film stock, which process is normally carried out at an elevated film surface-temperature. In the forming of composites wherein the first and second polymeric layers are of polycarbonate the film surface-temperature is 130 to 230° C. Exemplary thermoforming processes include differential air pressure thermoforming, match dye thermoforming, vacuum forming, plug assist-vacuum forming, draw forming, impact forming, rubber pad forming, hydroforming, drape molding and the like. Exemplary solid phase forming methods include cold rolling, impact extrusion, forging, forward extrusion, cold heading, and rubber-pad forming, e.g., as such methods are further described by P. M. Coffman in Soc. Plas. Eng. Journal, Vol. 25, January, 1969 (50-54) and Soc. Auto. Eng. Journal, Vol. 76, No. 6, 36-41 (1968).

In the forming operation, the entire composite or a portion thereof, is formed or shaped in a manner such that at least a portion of the composite undergoes a cumulative surface dimensional change of at least percent. The term “cumulative surface dimensional change” refers to the combined change of length and width wherein a decrease as well as an increase in a particular dimension is treated as a positive change. Either one or both surface dimensions may be changed in the forming operation. Techniques for observing surface dimensional changes are described by A. Nadai in Plasticity, McGraw-Hill (1931). Controlling the heating time in the forming operation is critical to ensure the composite is heated well and at the same time to prevent metal cracking. In this invention, the preferred heating time in the high pressure forming operation is 8 seconds.

The formed composite may be die-cut and then molded using Film Inset Molding technology. U.S. Pat. Nos. 3,654,062 and 6,117,384 that relate to Film Insert Molding, or as it is sometimes referred to In Mold Decoration, are incorporated herein by reference.

The following examples illustrate the invention and should not be construed as limiting the scope thereof.

Experimental Results

Experiment 1. Composites structured of polycarbonate layer/metal layer/adhesive layer/polycarbonate layer were prepared and their properties determined as shown below. The different metals used and their properties are shown in the Table 1. The adhesive used in the structures was Dispercoll U53, an aqueous anionic dispersion of a high molecular weight polyurethane with polymer content of 40 wt % and viscosity of 50 to 600 cps.

TABLE 1

| | Melting | | | |
|---|---|---|---|---|
| | Temperature | | Resistance | |
| Metal | (° C.) | Ductility | to oxidation | Formability |
| Cr | 1857 | Low | High | Fair |
| Al | 660 | High | Low | Fair |
| In/Sn (90/10) | 164 | High | High | Good |

The composites structured with the metals shown in the table were formed using high-pressure forming technology. The performance of the composite that included the In/Sn alloy had the best formability without cracking among the composites thus evaluated. The formation of oxide was observed in the Al-based composite; no such formation was observed for the alloy-based composite.

Experiment 2. Composites differing one from the others in terms of the adhesive layer were prepared and evaluated. The properties of these composites are shown in Table 2. The structures of all the composites shown in Table 2 were:

Polycarbonate/Chromium/Adhesive/polycarbonate.

The adhesive layers in all composites were 25 microns in thickness. The adhesives are aqueous anionic dispersion of high molecular weight polyurethanes. All are products of Bayer Polymers LLC.

TABLE 2

| | | | Peel adhesion^{a} | Metal |
|---|---|---|---|---|
| Adhesive | Crystallinity | Clarity | (lb/in) | Transfer^{b} |
| Dispercoll | Highly crystalline | Hazy | 1.2 | No |
| U53 | | | | |
| Dispercoll | Median | Hazy | 1.7 | No |
| U54 | crystalline | | | |
| Dispercoll | Amorphous | Clear | 2.4 | considerable |
| U42 | | | | |
| Dispercoll | Amorphous | Clear | 2.5 | considerable |
| UKA 8758 | | | | |

^{a}The peel adhesion was measured using the 180-degree peel test (ASTM D1000-66).
^{b}When the composites were separated between the adhesive layer and the chromium layer, some amount of chromium is transferred from the first polycarbonate layer to the adhesive layer if the adhesion of the adhesive to the second polycarbonate layer is high.

The amorphous adhesives, Dispercoll U42 and UKA 8758 provided higher adhesion to the chromium surface than the crystalline adhesives, Dispercoll U 53 and U54.

In a separate set of experiments, it was demonstrated that the amorphous adhesive, Dispercoll UKA 8758 provided a similar peel adhesion value (2.4 lb/in) to the surface of the In/Sn alloy as to the chromium surface.

For the crystalline adhesives, the failure always occurred at the adhesive-chromium interface. For the amorphous adhesives, a large amount of chromium was transferred from surface of the polycarbonate layer to the adhesive surface. The failure occurred at the chromium-polycarbonate interface due to the higher adhesion of the adhesive to the chromium surface than that of chromium to the polycarbonate layer surface.

Experiment 3: The composites structured as polycarbonate/ln/Sn alloy (90%/10%)/(Dispercoll UKA 8758)/polycarbonate were evaluated to determine the optimal thickness of the adhesive layer.

TABLE 3

| Coating thickness (micron) | Peel Adhesion (lb/in) | Metal Transfer |
|---|---|---|
| 25 | 2.5 | Yes |
| 18 | 1.7 | Some |
| 9 | 0.9 | No |

The results show that the peel adhesion values increase with increased thickness of the adhesive. At the low coating thickness (9 microns), the peel adhesion value is low, and failure occurs at the adhesive-metal interface. As the coating thickness increases, the peel adhesion values increase, and the strength of the adhesion bonding to the metal surface gradually surpasses that of the metal to the polymeric layer. At a coating thickness of 18 microns, most failures occurred at the adhesive-metal interface, but some failures occurred at the metal-polymeric layer interface. At the high coating thickness (25 microns), the peel adhesion reached a high value, and most failures occurred at the metal-polymeric layer interface, only a small portion of the failures at the adhesive-metal interface.

Experiment 4: A composite the structure of which was polycarbonate/Chromium/(Dispercoll UKA 8758)/polycarbonate, was evaluated to determine the optimum lamination temperature for the inventive composite. The lamination temperature referred to in Table 4 is the temperature of both the top and the bottom roller of the laminator.

TABLE 4

| Lamination Temperature (° F.) | Metal cracking | Metal transfer |
|---|---|---|
| 300 | Yes | Yes |
| 250 | Sometimes | Yes |
| 200 | No | Yes |
| 175 | No | Yes |
| 150 | No | No |

It was observed that the lamination temperature range of 175° F. to 200° F. was optimal because the adhesion of the adhesive to the chromium surface was sufficient and there was no metal cracking.

Experiment 5: Table 5 is a summary of the results of a series of experiments designed to determine the heating time during the high pressure forming. The structure of the composites thus tested polycarbonate/ln/Sn alloy (90 wt %/10 wt. %)/(Dispercoll UKA 8758)/polycarbonate.

TABLE 5

| Heating time (Seconds) | Results |
|---|---|
| 10 | The metal cracked but the laminate |
| | formed well. |
| 8 | The metal did not crack and the laminate |
| | formed well. |
| 6 | The metal did not crack but the laminate |
| | did not form well because it had not been |
| | heated long enough. |

Experiment 6: A formed composite of polycarbonate/ln/Sn alloy (90 wt. %/110 wt. %)/(Dispercoll UKA 8758)/polycarbonate was used as a film insert in the molding of a polycarbonate article. The thus molded article was then tested to determine the extent of delamination according to DaimlerChrysler MSCG-93. The article exhibited no delamination.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A multi-layered composite comprising in sequence a first polymeric layer, a metal layer, a water or solvent-based or hot-melt adhesive layer and a second polymeric layer, the polymeric layer in both instances having thicknesses independent one of the other of 25 to 1,000 microns, and the metal layer containing at least one member selected from the group consisting of titanium, aluminum, copper, silver, chromium, zirconium, tin, indium and their alloys.

2. The multi-layered composite of claim 1 wherein the metal layer comprises indium.

3. The multi-layered composite of claim 2 wherein the metal layer comprises indium-tin alloy that contains tin in a positive amount up to 95 wt. %.

4. The multi-layered composite of claim 3 wherein the alloy contains indium in an amount of up to 95 wt. %.

5. The multi-layered composite of claim 1 wherein the first polymeric layer contains at least one member selected from the group consisting of polycarbonate, polyester, polyacrylate, acrylonitrile-butadiene-styrene copolymer, polyamide, polyolefin, polyurethane, polyamide, polyimide and fluoropolymer.

6. The multi-layered composite of claim 1 wherein the second polymeric layer contains at least one member selected from the group consisting of polycarbonate, polyester, polyacrylate, acrylonitrile-butadiene-styrene copolymer, polyamide, polyolefin, polyurethane, polyamide, polyimide and fluoropolymer.

7. The multi-layered composite of claim 1 wherein the first polymeric layer and the second polymeric layer are compositionally different one form the other.

8. The multi-layered composite of claim 1 wherein the first polymeric layer and the second polymeric layer are compositionally identical.

9. The multi-layered composite of claim 1 wherein the first polymeric layer comprises polycarbonate.

10. The multi-layered composite of claim 1 wherein the second polymeric layer comprises polycarbonate.

11. The multi-layered composite of claim 9 wherein the both surfaces of the polycarbonate layer are glossy.

12. The multi-layered composite of claim 10 wherein surface of the second polycarbonate layer in contact with the adhesive layer is glossy.

13. The multi-layered composite of claim 12 wherein the second surface of the second polycarbonate layer is matte.

14. The multi-layered composite of claim 1 wherein the adhesive layer comprises a water-based adhesive.

15. The multi-layered composite of claim 1 wherein the adhesive layer comprises a solvent-based adhesive.

16. The multi-layered composite of claim 1 wherein the adhesive layer comprises a hot-melt adhesive.

17. The multi-layered composite of claim 1 wherein the adhesive layer comprises an aqueous anionic dispersions of high molecular weight polyurethane.

18. The multi-layered composite of claim 17 wherein the dispersion contains solid polymer in an amount of 10 to 80 wt. % and has a viscosity value in the range of 20 to 2000 cps.

19. A thermoplastically molded article comprising at least one polymeric resin selected from a group consisting of polycarbonate, acrylonitrile-butadiene-styrene copolymer, polyester and polyamide resins characterized in that to at least a portion of its surface there is bonded by film insert molding technique a formed multi-layered polymer composite comprising in sequence a first polymeric layer, a metal layer, a water or solvent-based crystalline adhesive layer and a second polymeric layer, the polymeric layers, in both instances, have thicknesses independent one of the other of 25 to 1,000 microns, and the metal layer contains at least one member selected from the group consisting of titanium, aluminum, copper, silver, chromium, zirconium, tin, indium and their alloys.

20. The molded article of claim 19 wherein said polymeric resin is polycarbonate.

21. The molded article of claim 19 wherein said first polymeric layer is polycarbonate.

22. The molded article of claim 19 wherein said second polymeric layer is polycarbonate.

23. The molded article of claim 19 wherein said first polymeric layer and second polymeric layer are polycarbonate.

24. The molded article of claim 19 wherein the metal layer comprises indium-tin alloy that contains tin in a positive amount up to 95 wt. %.

25. The molded article of claim 19 wherein the adhesive layer comprises an aqueous anionic dispersion of high molecular weight polyurethane.

26. The molded article of claim 19 wherein the adhesive layer comprises an aqueous anionic dispersion of high molecular weight amorphous polyurethane.

27. The molded article of claim 26 wherein the dispersion contains solid polymer in an amount of 10 to 80 wt. % and has a viscosity value in the range of 20 to 2000 cps.
